(19) United States
(12) Patent Application Publication
(10) Pub. No.: US 2005/0281513 A1
(43) Pub. Date: Dec. 22, 2005

(54) Module for transmitting and receiving optical signal based on optical fiber having slanted surface and method of manufacturing the same

(76) Inventors: Jung-Ho Choi, Gyeonggi-do (KR); Gi-Han Ryu, Gyeonggi-do (KR); Sang-Gil Shin, Gyeonggi-do (KR); Seung-Bae Park, Gyeonggi-do (KR)

Correspondence Address: JONES DAY, 222 EAST 41ST ST, NEW YORK, NY, 10017, US

(21) Appl. No.: 11/201,653

(22) Filed: Aug. 10, 2005

Related U.S. Application Data
(63) Continuation-in-part of application No. PCT/KR04/00484, filed on Mar. 8, 2004.

(30) Foreign Application Priority Data
Mar. 5, 2004 (KR) 10-2004-0014890

(51) Int. Cl. G02B 6/36

(52) U.S. Cl. 385/89; 385/49

(57) ABSTRACT

A module for transmitting and receiving optical signals based on an optical fiber with a slanted surface at an end is disclosed. The module includes, on a semiconductor substrate, a laser diode and a photodiode optically combined to the optical fiber. On the substrate, a surface-mounted laser diode; an optical fiber guided and installed in a groove to face with the laser diode, and having a slanted surface at an end; and a photodiode surface-mounted to place an optical activation region right below a horizontal projection plane of the slanted surface are provided. The slanted surface has an optical fiber coating layer for transmitting a transmitted signal output from the laser diode to the optical fiber and reflecting a received signal input from outside through the optical fiber. This module may have reduced dimensions, reduce manufacturing costs and time during packaging, and ensure high reliability by simple optical axis alignment.

### CROSS-REFERENCE TO RELATED APPLICATIONS

This application is a continuation-in-part of the International Application No. PCT/KR2004/000484, filed on Mar. 8, 2005, which in turn claims priority of Korean Application No. 10-2004-0014890.

### TECHNICAL FIELD

The present invention relates to a module for transmitting and receiving optical signals with different wavelengths, which generates optical signals of a certain wavelength, transmits optical signals to an optical fiber and detects optical signals of a certain wavelength received through an optical fiber, and a method of manufacturing the module. More particularly, the present invention relates to a device for transmitting and receiving optical signals with different wavelengths, which generates and detects an optical signal for optical communication using a laser diode and a photodiode, and a method of manufacturing the device.

### BACKGROUND OF THE INVENTION

Recently, FTTx (Fiber To The x) that connects an optical fiber to a subscriber unit (or a subscriber terminal) for a high-speed subscriber network has been actively researched, and FTTx for test network remains already constructed and operated in some regions so as to propagate FTTx.

In order to construct such FTTx, a module for transmitting and receiving optical signals is necessarily required for converting a digitalized electric signal into an optical signal of a certain wavelength, transmitting the optical signal to an optical fiber, detecting an optical signal of a certain wavelength received through the optical fiber, and then inversely converts the detected optical signal into a digitalized electric signal. To realize the optical signal transmitting/receiving module, there are recently widely used a laser diode (LD) for generating a corresponding optical signal in response to an electric signal and a photodiode (PD) for detecting an optical signal received through an optical fiber and then inversely converting the detected optical signal into an electric signal.

Meanwhile, an optical fiber used for optical communication allows bi-directional communication between transmitting and receiving parts. In this case, the transmitted and received optical signals use different wavelengths to prevent optical signals from being deteriorated due to mutual interference between the transmitted and received optical signals. For example, 1300 nm is allocated to the transmitted optical signal and 1550 nm is allocated to the received optical signal, or vice versa. Thus, in order to realize an optical signal transmitting/receiving module with a laser diode and a photodiode, there is needed a structure capable of transmitting and receiving optical signals with only one optical fiber by varying operation wavelengths.

For this purpose, it has already been proposed in the prior art that an optical signal transmitting/receiving module forms an optical waveguide, a WDM (Wavelength Division Multiplexing) and electrode pads on one substrate, and surface-mounts a laser diode (LD) and a photodiode (PD) on the electrode pads.

FIG. 1 is a schematic view showing that such an optical signal transmitting/receiving module with different wavelengths remains connected to an optical fiber.

Referring to FIG. 1, the conventional optical signal transmitting/receiving module includes a WDM 20, an optical waveguide 30, a laser diode 40 and a photodiode 50 on a silicon or silica substrate 10. The optical waveguide 30 has both ends, the one end combined with an optical fiber 60 and the other end diverged into two parts by means of the WDM 20 and then combined with the laser diode 40 and the photodiode 50, respectively.

In general, the WVDM 20 and the optical waveguide 30 are integrally formed on the substrate 10, and the laser diode 40 and the photodiode 50 are integrated on electrode pads (not shown) using surface mounting.

The WDM 20 transmits a transmitted signal, which is generated in the laser diode 40 and transmitted through the optical waveguide 30, to the optical fiber 60, and also transmits a received signal, which is transmitted from a remote place through the optical fiber 60, to the photodiode 50 via the optical waveguide 30.

Meanwhile, the received signal is input into the photodiode 50 perpendicularly to an advancing direction of the optical waveguide 30. Thus, one or two mirror surfaces are generally provided in a point where the optical waveguide 30 is combined with the photodiode 50 (though their combination is not shown in the figure) so that an optical activation region (i.e. an optical signal receiving portion) of the photodiode 50 is optically combined with the received signal.

Operation of the conventional optical signal transmitting/receiving module configured as mentioned above is described as follows. First, a received signal input from the optical fiber 60 is optically combined with and input into the optical waveguide 30 that is formed on the substrate 10 and has one channel. The input received signal advances along the optical waveguide 30 and then, when passing through the WDM 20, advances along an optical waveguide 30 at an end of which the photodiode 50 is combined. Subsequently, the received signal is reflected on a mirror surface provided in the end of the optical waveguide 30 and then optically combined with and input into the optical activation region of the photodiode 50. The transmitted signal output from the laser diode 40 is combined with and input into the optical waveguide 30, and then the input transmitted signal advances through the optical waveguide 30 and the WDM 20 and is optically combined with the optical fiber 60.

The aforementioned conventional optical signal transmitting/receiving module has a limitation in decreasing its weight, thickness, length and size since the WDM 20, the laser diode 40 and the photodiode 50 are integrated on the substrate 10 at any certain intervals and also interconnected each other by means of the optical waveguide 30.

The conventional optical signal transmitting/receiving module also includes a plurality of optical elements such as the optical waveguide 30, the WDM 20 and the mirror surface in addition to the optical fiber 60, the laser diode 40 and the photodiode 50. Thus, much time and cost are inevitably taken to form optical axis alignment among the optical elements in the packaging procedure of the optical signal transmitting/receiving module, therefore there is also a limitation in reducing the manufacturing cost.

In addition, the conventional optical signal transmitting/receiving module is apt to cause a cross talk generated when the transmitted signal output from the laser diode 40 is leaked and then input to the optical signal receiving portion, namely the photodiode 50, in case that the optical elements are arranged in a narrow space.

### DISCLOSURE OF INVENTION

The present invention is designed to solve the problems of the prior art, and therefore an object of the invention is to provide a different-wavelength optical signal transmitting/receiving module having an improved structure capable of decreasing its weight, thickness, length and size since it is not provided with optical elements such as an optical waveguide, a WDM and a mirror surface, and also capable of reducing the manufacturing cost and time during the packaging procedure, and a method of manufacturing the module.

Another object of the present invention is to provide a module for transmitting and receiving optical signals, which is capable of reducing a cross talk caused when the transmitted signal is leaked and then input to optical elements receiving signals, and a method of manufacturing the module.

In order to accomplish the above object, the present invention provides a module for transmitting and receiving optical signals, which includes, on a semiconductor substrate, a laser diode and a photodiode optically combined to an optical fiber, wherein, on the semiconductor substrate, there are provided a surface-mounted laser diode; an optical fiber guided and installed in a predetermined groove to face with the laser diode and having a slanted surface at an end thereof; and a photodiode surface-mounted to place an optical activation region right below a horizontal projection plane of the slanted surface, and wherein, on the slanted surface, an optical fiber coating layer for transmitting a transmitted signal output from the laser diode to the optical fiber and reflecting a received signal input from outside through the optical fiber is provided.

Preferably, the laser diode is surface-mounted in a laser diode mounting groove formed on the substrate. At this time, horizontal positions and vertical depths of the laser diode mounting groove and the optical fiber mounting groove are preferably controlled so that an advancing axis of the transmitted signal output from the laser diode is substantially identical with a central axis of the optical fiber. The laser diode mounting groove may be provided with an electrode pad for applying a operating electric power to the laser diode. In this case, the laser diode is surface-mounted on the electrode pad by means of the flip-chip process.

In the present invention, a photodiode coating layer for transmitting a received signal received from outside through the optical fiber and reflecting a transmitted signal output from the laser diode is preferably provided on a surface of the photodiode. In addition, the photodiode is preferably surface-mounted in a photodiode mounting groove formed on the substrate. At this time, horizontal positions and vertical depths of the photodiode mounting groove and the optical fiber mounting groove are preferably controlled so that the received signal input from the outside and reflected right downward to the slanted surface is input to the optical activation region of the photodiode. The photodiode mounting groove may be provided with an electrode pad for applying a operating electric power to the photodiode. In this case, the photodiode is preferably surface-mounted on the electrode pad by means of the flip-chip process.

In the present invention, the slanted surface is preferably inclined at a angle suitable for inputting the received signal, input from outside through the optical fiber, to an optical activation region of the photodiode, and suitable for inputting the transmitted signal output from the laser diode to the optical fiber.

In the present invention, the module may further include epoxy having a controlled refractive index, which is coated between the slanted surface and a transmitted signal output region of the laser diode and between the optical activation region of the photodiode and the slanted surface of the optical fiber so as to prevent interfacial reflection of the optical signal.

In another aspect of the invention, there is provided a module for transmitting and receiving optical signals, which includes, on a semiconductor substrate, a laser diode and a photodiode optically combined to an optical fiber, wherein, on the substrate, there are provided a surface-mounted photodiode; an optical fiber guided and installed in a predetermined groove to face with the photodiode, and having a slanted surface at an end thereof; and a laser diode surface-mounted right below a horizontal projection plane of the slanted surface, and wherein an optical fiber coating layer for reflecting a transmitted signal output from the laser diode so as to input the transmitted signal to the optical fiber and transmitting a received signal input from an outside through the optical fiber is provided on the slanted surface.

In order to accomplish another object of the invention, there is also provided a method of manufacturing a module for transmitting and receiving optical signals, which includes, on a semiconductor substrate, a laser diode and a photodiode optically combined to an optical fiber having a slanted surface at an end thereof, the method including: (a) forming a laser diode mounting groove, a photodiode mounting groove and an optical fiber mounting groove on the semiconductor substrate, wherein horizontal position and vertical depth of each of the grooves are controlled so that an advancing axis of a transmitted signal output from the laser diode is substantially coincided with a central axis of the optical fiber, and a received signal input from the outside and reflected just downward from the slanted surface is input to an optical activation region of the photodiode; (b) forming electrode pads in the photodiode mounting groove and the laser diode mounting groove, respectively, so as to apply electric power to the photodiode and the laser diode; (c) surface-mounting the photodiode and the laser diode on the corresponding electrode pads with optical axis alignment; and (d) installing an optical fiber in the optical fiber mounting groove so that the optical activation region of the photodiode is placed right below the slanted surface of the optical fiber.

Preferably, the photodiode is provided with a photodiode coating layer for transmitting a received signal input from outside through the optical fiber and reflecting a transmitted signal output from the laser diode, on a surface thereof.

In another aspect of the invention, there is also provided a method of manufacturing a module for transmitting and receiving optical signals, which includes, on a semiconductor substrate, a laser diode and a photodiode optically combined to an optical fiber having a slanted surface at an end thereof, the method including: (a) forming a laser diode mounting groove, a photodiode mounting groove and an optical fiber mounting groove on the semiconductor substrate, wherein horizontal position and vertical depth of each of the grooves are controlled so that a transmitted signal output from the laser diode just downward to the slanted surface is reflected on the slanted surface and then input to the optical fiber, and an advancing axis of a received signal input to the photodiode is substantially coincided with a central axis of the optical fiber; (b) forming electrode pads in the photodiode mounting groove and the laser diode mounting groove respectively so as to apply electric power to the photodiode and the laser diode; (c) surface-mounting the photodiode and the laser diode on the corresponding electrode pads with optical axis alignment; and (d) installing an optical fiber in the optical fiber mounting groove so that the laser diode is positioned right below the slanted surface of the optical fiber.

In the present invention, the surface mounting of the step (c) is preferably accomplished by means of a flip-chip process using a solder bump.

The method of the present invention may further include: coating and curing epoxy having a controlled refractive index between the slanted surface and a transmitted signal output region of the laser diode and between the optical activation region of the photodiode and the slanted surface of the optical fiber so as to prevent interfacial reflection of the optical signal.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic view showing a module for transmitting and receiving optical signals according to the prior art;

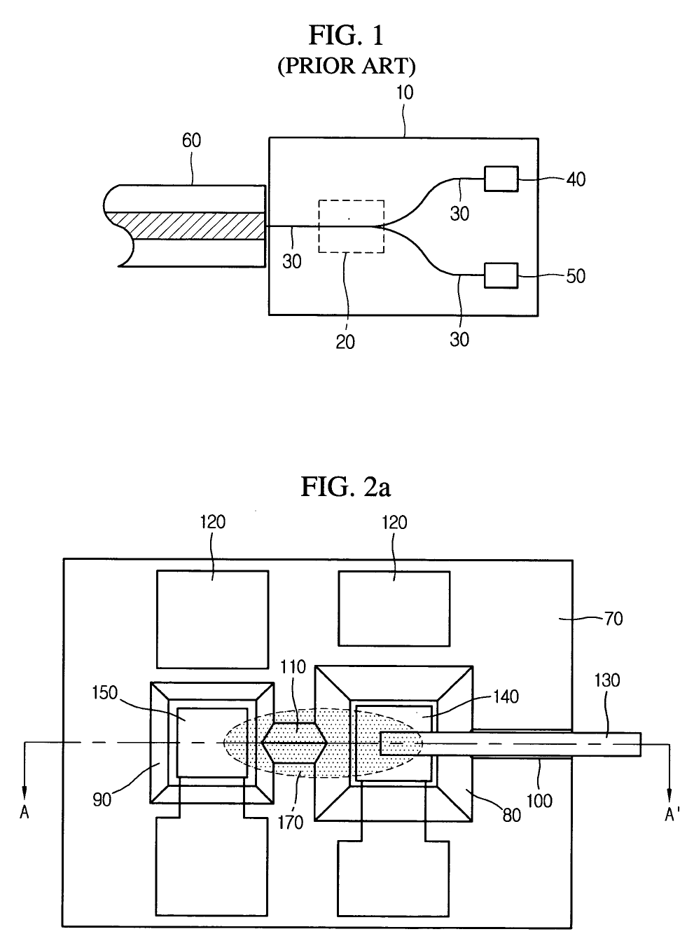

FIG. 2a is a plane view showing a module for transmitting and receiving optical signals according to an embodiment of the present invention, and FIG. 2b is a sectional view taken along the line A-A′ of FIG. 2a;

FIG. 3 is a schematic view illustrating operation of the module for transmitting and receiving optical signals according to the embodiment of the present invention;

FIGS. 4a to 4d sequentially show processes of a method for manufacturing the module for transmitting and receiving optical signals according to the embodiment of the present invention, seen from a upper view of a substrate; and

FIGS. 5a to 5d sequentially show processes of the method for manufacturing the module for transmitting and receiving optical signals according to the embodiment of the present invention, seen from a side view of the substrate.

### BEST MODES FOR CARRYING OUT THE INVENTION

Hereinafter, preferred embodiments of the present invention will be described in detail referring to the accompanying drawings. Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

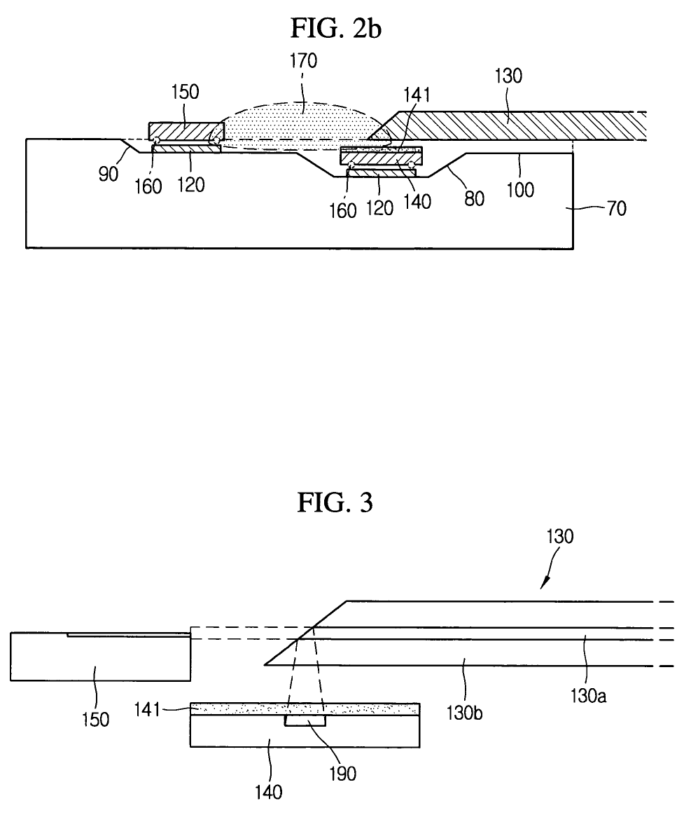

FIG. 2a is a plane view showing a module for transmitting and receiving optical signals according to a preferred embodiment of the present invention, and FIG. 2b is a sectional view taken along the line A-A′ of FIG. 2a.

Referring to FIGS. 2a and 2b, the module for transmitting and receiving optical signals according to the present invention basically has a structure wherein optical elements for transmitting and receiving optical signals are integrated on a substrate 70 by means of surface mounting, the substrate 70 composed of silicon or compound semiconductors.

Specifically, the upper portion of the substrate 70 is provided with a photodiode mounting groove 80, a laser diode mounting groove 90 and an optical fiber mounting groove 100 on which optical elements are placed. The photodiode mounting groove 80 and the laser diode mounting groove 90 are connected with each other by means of an optical guide groove 110, and the photodiode mounting groove 80 and the laser diode mounting groove 90 are provided with patterned electrode pads 120. Positions and heights of the mounting grooves on which each of the optical elements is placed are suitably controlled so that the elements may form optical axis alignment. The optical fiber mounting groove 100 is preferably formed in, but not limited to, a V shape.

Each of the grooves 80, 90, 100 and 110 may be formed using photolithography well known in the art. In addition, the electrode pad may be formed by depositing a material film at a predetermined thickness to constitute the electrode pad on a front surface of the substrate, followed by patterning the film by means of photolithography. The material film may be made of, but not limited to, Au, Ag, Cu, Al or their alloys.

An optical fiber 130 is installed in the optical fiber mounting groove 100, the optical fiber 130 composed of a core and a clad and having a slanted surface provided in one end of the optical fiber 130 at a predetermined angle. Here, the slanted surface preferably makes an angle of 45 degrees. Also in the photodiode mounting groove 80 and the laser diode mounting groove 90, a photodiode 140 and a laser diode 150 are surface-mounted on each of the electrode pads 120.

In the embodiment of the present invention, the photodiode 140 and the laser diode 150 are firmly fixed by means of a flip-chip bonding process using a solder bump 160 so as to be electrically connected to the electrode pads 120. By means of such electric connection, the photodiode 140 and the laser diode 150 are supplied with a electric power required for their operation.

Meanwhile, the photodiode 140 and the laser diode 150 should have accurately controlled heights so as to ensure optical axis alignment with the optical fiber 130. For such accurate height control, the reflow technique may be applied in the flip-chip bonding process, wherein an amount of the solder bump 160 is accurately controlled when the photodiode 140 and the laser diode 150 are electrically connected to the electrode pads 120.

Preferably, on the surface of the photodiode 140, a photodiode coating layer 141 having a predetermined thickness may be provided. In case that any transmitted signal is leaked from the laser diode 150, the photodiode coating layer 141 acts for preventing the leaked transmitted signal from being input to the photodiode 140.

The photodiode coating layer 141 is a wavelength-selective mirror, which acts as a glass having a reflectivity substantially near to 0% in a longer wavelength range (e.g., at 1.550 nm) and as a mirror having a reflectivity substantially near to 100% in a shorter wavelength range (e.g., at 1.310 nm). The wavelength-selective mirror may be made to have a photonic crystal structure or a photonic band gap structure by using well-known techniques. However, the present invention is not limited to those cases.

According to the present invention, on the slanted surface of the optical fiber 130, an optical fiber coating layer having a predetermined thickness is provided. The optical fiber coating layer is another wavelength-selective mirror, which acts as a mirror having a reflectivity substantially near to 100% in a longer wavelength range (e.g., at 1.550 nm) and as a glass having a reflectivity substantially near to 0% in a shorter wavelength range (e.g., at 1.310 nm). The wavelength-selective mirror may be made to have a photonic crystal structure or a photonic band gap structure by using well-known conventional techniques. However, the present invention is not limited to those cases.

Meanwhile, when a received signal reflected on the slanted surface provided in the end of the optical fiber 130 is input to the photodiode 140, and when a transmitted signal output from the laser diode 150 is optically combined with the core of the optical fiber 130, the optical signals is unnecessarily reflected on all incidence interfaces of the optical fibers. Thus, adhesive epoxy 170 with a controlled refractive index may be coated over the optical fiber, the photodiode 140 and the laser diode 150 in order to prevent such unnecessary reflection. Here, the refractive index of the epoxy may be controlled using a common method such as controlling a component ratio. The epoxy 170 coated as mentioned above may give an additional benefit that the optical fiber is firmly fixed in the optical fiber mounting groove 100. In addition, a lens means (not shown) may be further provided between the laser diode 150 and the optical fiber 130 in order to improve optical combination efficiency of the transmitted signal.

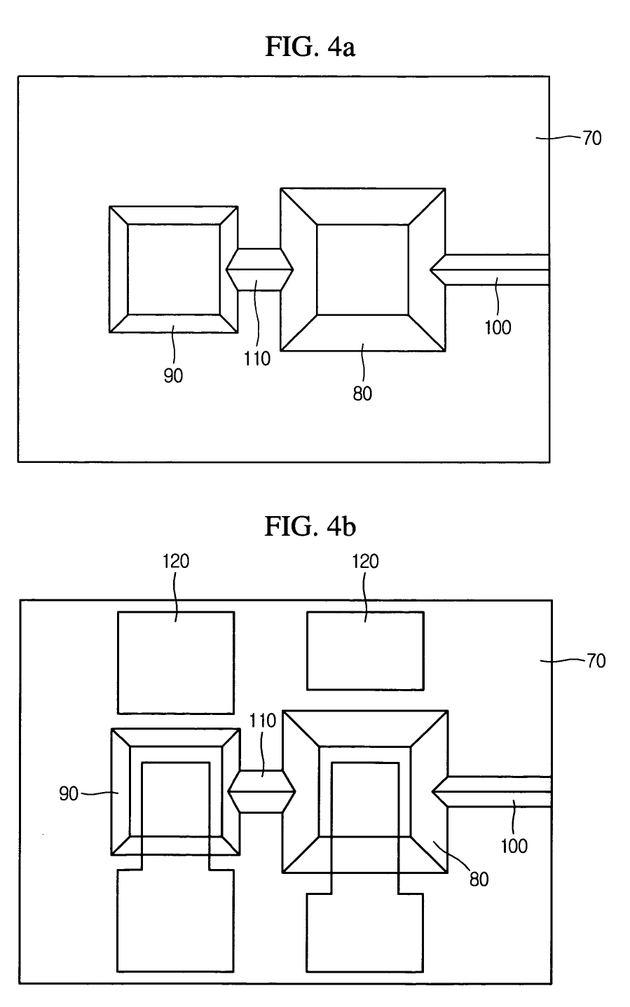

Now, operation of the module for transmitting and receiving optical signals according to the present invention is described with reference to FIG. 3. FIG. 3 shows only optical elements, without showing a substrate.

Referring to FIG. 3, a received signal input from the outside advances along the core 130a of the optical fiber 130 placed in the optical fiber mounting groove, and then reaches the slanted surface provided in the end of the optical fiber 130. The received signal reaching the slanted surface is reflected on the wavelength-selective mirror of the optical fiber coating layer provided in the slanted surface since it has the longer wavelength. Accordingly, the received signal is output out of the optical fiber 130 through the clad 130b of the optical fiber 130.

The output received signal reaches the surface of the photodiode 140 positioned just below the slanted surface provided at the end of the optical fiber 130. The received signal passes through the wavelength-selective mirror of the photodiode coating layer 141 provided in the surface of the photodiode 140 and then is input to the optical activation region 190 of the photodiode 140 since it has a longer wavelength. The received signal input as mentioned above is converted into an electric signal by means of the photodiode 140, and then output to a signal processing circuit.

Meanwhile, in case that epoxy having a suitable refractive index is interposed between the photodiode 140 and the lower portion of the end of the optical fiber 130, optical reflection is prevented on the interface between different materials, so that the received signal output from the clad 130b of the optical fiber 130 is optically combined and input to the optical activation region 190 of the photodiode 140 without any optical loss.

Meanwhile, the transmitted signal output from the laser diode 150 reaches the slanted surface provided at the end of the optical fiber 130 through a free space or the epoxy coating layer. In particular, if the transmitted signal is input to the slanted surface of the optical fiber 130 through the epoxy coating layer with a controlled refractive index, it is possible to prevent the transmitted signal from being reflected on the incidence interface, thereby preventing loss of the transmitted signal. Since the transmitted signal reaching the slanted surface has a shorter wavelength, the transmitted signal passes through the wavelength-selective mirror that is the optical fiber coating layer provided in the slanted surface, and then is optically combined with the core 130a of the optical fiber 130. The transmitted signal combined with the optical fiber 130 as mentioned above is transmitted along a subscriber network.

Meanwhile, since the optical fiber 130, the photodiode 140 and the laser diode 150 are arranged very close to each other, some of the transmitted signals output from the laser diode 150 may be input to the photodiode 140 by means of scattering, reflection etc. At this time, since the transmitted signal from the laser diode 150 has a short wavelength, the scattered transmitted signal is reflected on the photodiode coating layer 141 that is a wavelength-selective mirror, when it reaches the photodiode 140. Thus, the transmitted signal output from the laser diode 150 will be not input to the photodiode 140, thereby reducing a cross talk.

Meanwhile, in case that a lens means (not shown) is provided between the laser diode 150 and the optical fiber 130, optical combination efficiency of the transmitted signal may be further improved.

In the module for transmitting and receiving optical signals as described above, it is described that the photodiode 140 is surface-mounted right below the optical fiber 130, and the laser diode 150 is surface-mounted at the front facing with the optical fiber 130, but it also should be understood that the module for transmitting and receiving optical signals may also be configured in such a way that the laser diode is surface-mounted right below the optical fiber, and the photodiode is surface-mounted at the front of the optical fiber.

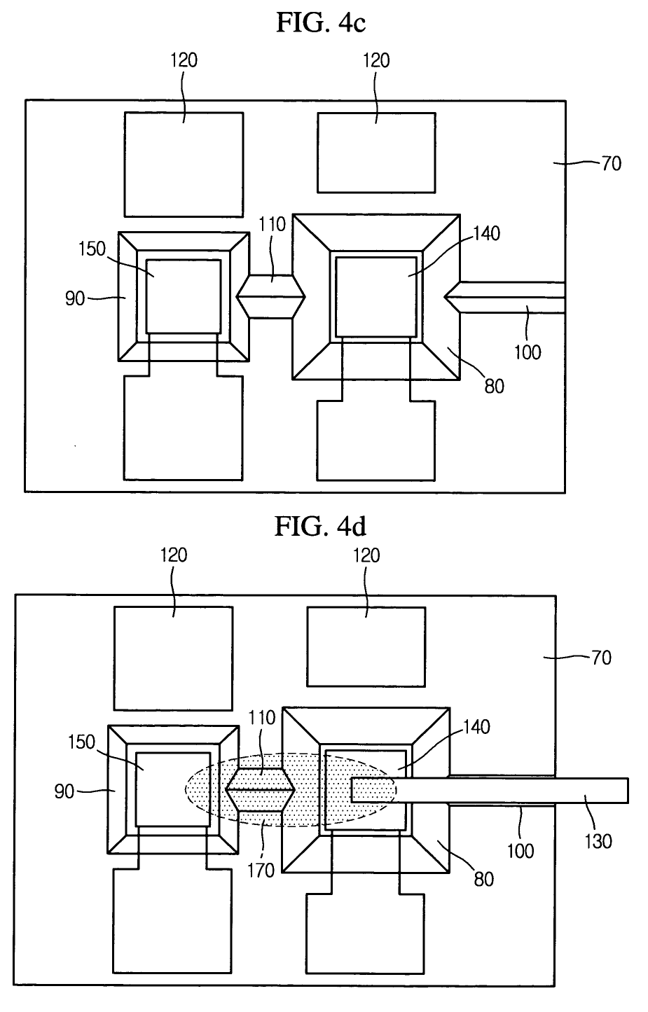

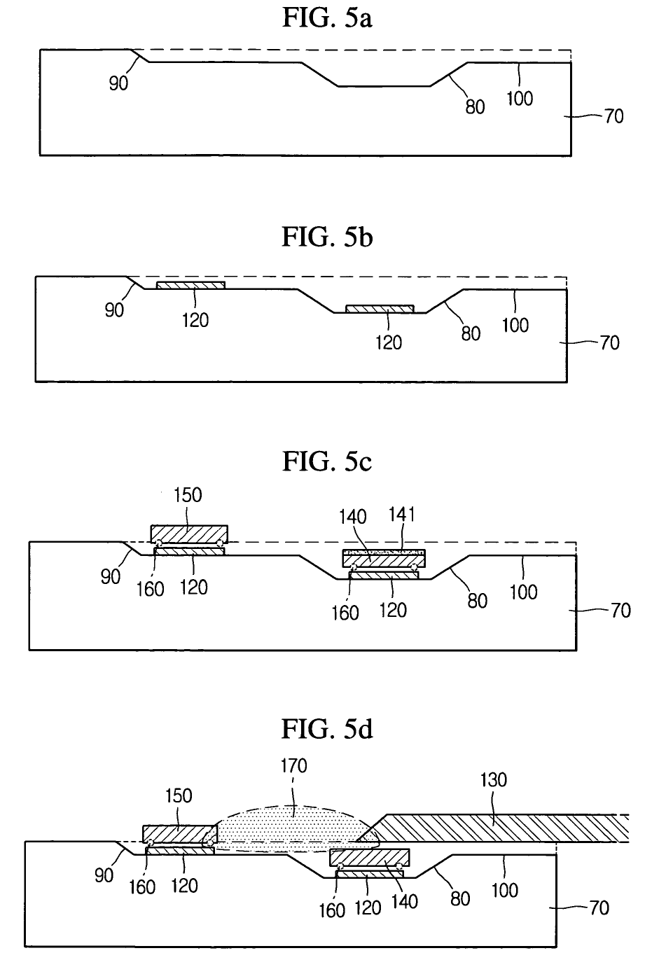

FIGS. 4a to 4d sequentially show processes of a method for manufacturing the module for transmitting and receiving optical signals according to the embodiment of the present invention, seen from a upper view of a substrate; and FIGS. 5a to 5d sequentially show processes of the method for manufacturing the module for transmitting and receiving optical signals according to the embodiment of the present invention, seen from a cross sectional direction of the line A-A′ of the substrate. Hereinafter, the method for manufacturing the module for transmitting and receiving optical signals according to the present invention will be described in detail with reference to FIGS. 4a to 4d and FIGS. 5a to 5d.

First, the substrate 70 is prepared to manufacture the optical signal transmitting/receiving module as shown in FIGS. 4a and 5a, and then a photolithography process is applied to form the photodiode mounting groove 80, the laser diode mounting groove 90, the optical fiber mounting groove 100 and the optical guide groove 110 on the substrate.

At this time, since the sidewalls of each groove are preferably inclined to the bottom, the etching method, preferably an anisotrophic etching method is adopted when the lithography process is applied. In addition, each of the grooves are preferably symmetric on the basis of the cross sectional cut line A-A′.

The material film is then deposited to form the electrode pad 120 on the substrate, and then patterned by means of photolithography to form the electrode pads 120 on the bottoms of the laser diode mounting groove 90 and the photodiode mounting groove 80 as shown in FIGS. 4b and 5b.

Subsequently, the flip-chip process using the solder bump 160 is applied to surface-mount the photodiode 140 and the laser diode 150 on the electrode pads 120 formed in the photodiode mounting groove 80 and the laser diode mounting groove 90, respectively, as shown in FIGS. 4c and 5c. At this time, if it is considered that the surface-mounted photodiode 140 and the surface-mounted laser diode 150 should form optical axis alignment with an optical fiber to be installed in the optical fiber mounting groove 100, it is preferable that an amount of the solder bump 160 is accurately controlled so that heights of the photodiode 140 and the laser diode 150 are accurately adjusted.

In order to prevent a cross talk, the photodiode coating layer 141 acting as the wavelength-selective mirror is preferably provided on the surface of the photodiode.

Subsequently, as shown in FIGS. 4d and 5d, the optical fiber 130 is installed in the optical fiber mounting groove 100 formed on the substrate 70, the optical fiber 130 having the slanted surface on which the optical fiber coating layer is coated as the wavelength-selective mirror. At this time, an installation position of the optical fiber 130 is preferably selected from a suitable position so that the received signal input through the optical fiber 130 may be reflected over the slanted surface and then accurately input to the optical activation region of the photodiode 140.

After the optical fiber 130 is installed as mentioned above, the epoxy with a controlled refractive index is coated on a transmitted signal output region of the laser diode 150, the optical guide groove 110, a space between the photodiode 140 and the optical fiber 130, and the slanted surface of the optical fiber 130 and then the resulting epoxy is cured. As a result, the method of manufacturing a module for transmitting and receiving optical signals according to the embodiment of the present invention is completed.

In the method of manufacturing a module for transmitting and receiving optical signals as described above, it is described that the photodiode 140 is surface-mounted right below the optical fiber 130, and the laser diode 150 is surface-mounted at the front facing with the optical fiber 130, but it also should be understood that the module for transmitting and receiving optical signals may also be configured so that the laser diode is surface-mounted right below the optical fiber, and the photodiode is surface-mounted at the front of the optical fiber.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

In one aspect of the invention, the number of optical elements required for manufacturing an optical signal transmitting/receiving module is minimized, thereby reducing costs and time required for the packing process of the optical signal transmitting/receiving module.

In another aspect of the invention, an optical waveguide, a WDM (Wavelength Division Multiplexing) for dividing the transmitted and received signals, and a separate mirror surface structure, which are used in the prior art, are excluded, and an optical path is simplified to the maximum using an optical fiber with the slanted surface on which a wavelength-selective mirror is coated, so it is possible to decrease the weight, thickness, length and size of the optical signal transmitting/receiving module.

In still another aspect of the invention, since the number of optical elements for configuration of the optical signal transmitting/receiving module is small and the optical path for the optical signal transmitting/receiving operation is simple, it is possible to reduce errors in optical axis alignment during the packaging process of the module accordingly, thereby ensuring high reliability of the optical signal transmitting/receiving module.

In further another aspect of the invention, in case that the transmitted signal is leaked out by scattering and input to optical elements receiving signals, the present invention may reduce the generation of cross talk, the optical signal transmitting/receiving module may ensure better quality and accuracy optical in transmitting and receiving optical signals.

1. A module for transmitting and receiving optical signals, which includes, on a semiconductor substrate, a laser diode and a photodiode optically combined to an optical fiber,
wherein, on the semiconductor substrate, there are provided a surface-mounted laser diode; an optical fiber guided and installed in a predetermined groove to face with the laser diode and having a slanted surface at an end thereof; and a photodiode surface-mounted to place an optical activation region right below a horizontal projection plane of the slanted surface, and
wherein, on the slanted surface, an optical fiber coating layer for transmitting a transmitted signal output from the laser diode to the optical fiber and reflecting a received signal input from outside through the optical fiber is provided.

2. The module for transmitting and receiving optical signals according to the claim 1,
wherein the laser diode is surface-mounted in a laser diode mounting groove formed on the substrate.

3. The module for transmitting and receiving optical signals according to the claim 2,
wherein horizontal positions and vertical depths of the laser diode mounting groove and the optical fiber mounting groove are controlled so that an advancing axis of the transmitted signal output from the laser diode is substantially identical with a central axis of the optical fiber.

4. The module for transmitting and receiving optical signals according to the claim 2,
wherein the laser diode mounting groove is provided with an electrode pad for applying a operating electric power to the laser diode, and
wherein the laser diode is surface-mounted on the electrode pad.

5. The module for transmitting and receiving optical signals according to the claim 4,
wherein the laser diode is surface-mounted by means of a flip-chip process using a solder bump.

6. The module for transmitting and receiving optical signals according to the claim 1,
wherein a photodiode coating layer for transmitting a received signal received from outside through the optical fiber and reflecting a transmitted signal output from the laser diode is provided on a surface of the photodiode.

7. The module for transmitting and receiving optical signals according to claim 1,
wherein the photodiode is surface-mounted in a photodiode mounting groove formed on the substrate.

8. The module for transmitting and receiving optical signals according to the claim 7,
wherein horizontal positions and vertical depths of the photodiode mounting groove and the optical fiber mounting groove are controlled so that the received signal input from the outside and reflected right downward to the slanted surface is input to the optical activation region of the photodiode.

9. The module for transmitting and receiving optical signals according to the claim 7,
wherein the photodiode mounting groove is provided with an electrode pad for applying a operating electric power to the photodiode, and
wherein the photodiode is surface-mounted on the electrode pad.

10. The module for transmitting and receiving optical signals according to the claim 9,
wherein the photodiode is surface-mounted on the electrode pad by means of a flip-chip process using a solder bump.

11. The module for transmitting and receiving optical signals according to claim 1,
wherein the slanted surface is inclined at a angle suitable for inputting the received signal, input from outside through the optical fiber, to an optical activation region of the photodiode, and suitable for inputting the transmitted signal output from the laser diode to the optical fiber.

12. The module for transmitting and receiving optical signals according to claim 1,
wherein the module further includes epoxy having a controlled refractive index, which is coated between the slanted surface and a transmitted signal output region of the laser diode and between the optical activation region of the photodiode and the slanted surface of the optical fiber so as to prevent interfacial reflection of the optical signal.

13. A module for transmitting and receiving optical signals, which includes, on a semiconductor substrate, a laser diode and a photodiode optically combined to an optical fiber,
wherein, on the substrate, there are provided a surface-mounted photodiode; an optical fiber guided and installed in a predetermined groove to face with the photodiode, and having a slanted surface at an end thereof; and a laser diode surface-mounted right below a horizontal projection plane of the slanted surface, and
wherein an optical fiber coating layer for reflecting a transmitted signal output from the laser diode so as to input the transmitted signal to the optical fiber and transmitting a received signal input from an outside through the optical fiber is provided on the slanted surface.

14. The module for transmitting and receiving optical signals according to claim 13,
wherein the slanted surface is inclined at a angle suitable for inputting the received signal, input from outside through the optical fiber, to an optical activation region of the photodiode, and suitable for inputting the transmitted signal output from the laser diode to the optical fiber.

15. The module for transmitting and receiving optical signals according to claim 13,
wherein the module further includes epoxy having a controlled refractive index, which is coated between the slanted surface and a transmitted signal output region of the laser diode and between the optical activation region of the photodiode and the slanted surface of the optical fiber so as to prevent interfacial reflection of the optical signal.

16. A method of manufacturing a module for transmitting and receiving optical signals, which includes, on a semiconductor substrate, a laser diode and a photodiode optically combined to an optical fiber having a slanted surface at an end thereof, the method comprising:
(a) forming a laser diode mounting groove, a photodiode mounting groove and an optical fiber mounting groove on the semiconductor substrate, wherein horizontal position and vertical depth of each of the grooves are controlled so that an advancing axis of a transmitted signal output from the laser diode is substantially coincided with a central axis of the optical fiber, and a received signal input from the outside and reflected just downward from the slanted surface is input to an optical activation region of the photodiode;
(b) forming electrode pads in the photodiode mounting groove and the laser diode mounting groove, respectively, so as to apply electric power to the photodiode and the laser diode;
(c) surface-mounting the photodiode and the laser diode on the corresponding electrode pads with optical axis alignment; and
(d) installing an optical fiber in the optical fiber mounting groove so that the optical activation region of the photodiode is placed right below the slanted surface of the optical fiber.

17. The method of manufacturing a module for transmitting and receiving optical signals according to the claim 16,
wherein the photodiode is provided with a photodiode coating layer for transmitting a received signal input from outside through the optical fiber and reflecting a transmitted signal output from the laser diode, on a surface thereof.

18. The method of manufacturing a module for transmitting and receiving optical signals according to claim 16,
wherein the surface mounting of the step (c) is accomplished by means of a flip-chip process using a solder bump.

19. The method of manufacturing a module for transmitting and receiving optical signals according to claim 16, after the step (d) of installing the optical fiber, further comprising:
coating and curing epoxy having a controlled refractive index between the slanted surface and a transmitted signal output region of the laser diode and between the optical activation region of the photodiode and the slanted surface of the optical fiber so as to prevent interfacial reflection of the optical signal.

20. A method of manufacturing a module for transmitting and receiving optical signals, which includes, on a semiconductor substrate, a laser diode and a photodiode optically combined to an optical fiber having a slanted surface at an end thereof, the method comprising:
(a) forming a laser diode mounting groove, a photodiode mounting groove and an optical fiber mounting groove on the semiconductor substrate, wherein horizontal position and vertical depth of each of the grooves are controlled so that a transmitted signal output from the laser diode just downward to the slanted surface is reflected on the slanted surface and then input to the optical fiber, and an advancing axis of a received signal input to the photodiode is substantially coincided with a central axis of the optical fiber;
(b) forming electrode pads in the photodiode mounting groove and the laser diode mounting groove respectively so as to apply electric power to the photodiode and the laser diode;
(c) surface-mounting the photodiode and the laser diode on the corresponding electrode pads with optical axis alignment; and
(d) installing an optical fiber in the optical fiber mounting groove so that the laser diode is positioned right below the slanted surface of the optical fiber.

21. The method of manufacturing a module for transmitting and receiving optical signals according to claim 20,
wherein the surface mounting of the step (c) is accomplished by means of a flip-chip process using a solder bump.

22. The method of manufacturing a module for transmitting and receiving optical signals according to claim 20, after the step (d) of installing the optical fiber, further comprising:
coating and curing epoxy having a controlled refractive index between the slanted surface and a transmitted signal output region of the laser diode and between the optical activation region of the photodiode and the slanted surface of the optical fiber so as to prevent interfacial reflection of the optical signal.
